(19) United States
(12) Patent Application Publication
(10) Pub. No.: US 2017/0142273 A1
(43) Pub. Date: May 18, 2017

(54) IMAGE READING DEVICE

(71) Applicant: Oki Data Corporation, Tokyo (JP)

(72) Inventor: Hidenori UEDA, Tokyo (JP)

(21) Appl. No.: 15/298,143

(22) Filed: Oct. 19, 2016

(30) Foreign Application Priority Data
Nov. 18, 2015 (JP) 2015-225678

(51) Int. Cl. H04N 1/00

(52) U.S. Cl. CPC H04N 1/00782; H04N 1/00588; H04N 1/00705; H04N 1/00745; H04N 1/00713; H04N 2201/0094; H04N 2201/0081

(57) ABSTRACT

An image reading device includes a carrying part that carries a manuscript medium along a carrying path along which the manuscript medium is carried, a reading part that is arranged on the carrying path and sequentially generates read data by performing a reading operation, a memory that stores the read data by performing a writing operation, and a controller that detects a leading edge of the manuscript medium based on the read data and starts the writing operation of the read data to the memory based on a result of the detection.

### CROSS REFERENCE TO RELATED APPLICATIONS

This application claims priority under 35 USC 119 to Japanese Patent Application No. 2015-225678 filed on Nov. 18, 2015 original document, the entire contents which are incorporated herein by reference.

### TECHNICAL FIELD

The present invention relates to an image reading device that reads information printed on a manuscript medium.

### BACKGROUND

In an image reading device, an auto document feeder (ADF) is provided and a plurality of manuscript media are fed one by one to a scanner part. For example, Patent Document 1 discloses an auto document feeder in which a reading start signal is transmitted after a predetermined time period has elapsed since a sensor arranged on an upstream side of an image reading part detects a leading edge of a manuscript medium.

### RELATED ART

[Patent Document 1]

Japanese Laid Open Patent Publication 2006-33549

However, in an image reading device, in general, it is desirable that information printed on a manuscript medium be properly read.

The present invention is accomplished in view of such a problem and is intended to provide an image reading device that allows information printed on the manuscript medium to be properly read.

### SUMMARY

An image reading device disclosed in the application includes a carrying part that carries a manuscript medium along a carrying path along which the manuscript medium is carried, a reading part that is arranged on the carrying path and sequentially generates read data by performing a reading operation, a memory that stores the read data by performing a writing operation, and a controller that detects a leading edge of the manuscript medium based on the read data and starts the writing operation of the read data to the memory based on a result of the detection.

According to the image reading device of the present invention, the leading edge of the manuscript medium is detected based on the read data, and the writing of the read data to the memory is started based on a result of the detection. Therefore, the information printed on the manuscript medium can be properly read.

### BRIEF DESCRIPTION OF THE DRAWINGS

FIG. 1 is a perspective view illustrating a configuration example of a multifunction peripheral according to an embodiment of the present invention.

FIG. 2 is a cross-sectional view illustrating a configuration example of an image reading unit illustrated in FIG. 1.

FIG. 3 is a plan view illustrating a configuration example of a reading part illustrated in FIG. 2.

FIG. 4 is an explanatory diagram illustrating an operation example of the reading part illustrated in FIG. 2.

FIG. 5 is a cross-sectional view illustrating a configuration example of an image forming unit illustrated in FIG. 1.

FIG. 6 is a block diagram illustrating an example of a control mechanism of the multifunction peripheral illustrated in FIG. 1.

FIG. 7 is a block diagram illustrating an example of a control mechanism of the image reading unit illustrated in FIG. 2.

FIG. 8 is a flow diagram illustrating an operation example of the image reading unit illustrated in FIG. 2.

FIG. 9 is a waveform diagram illustrating an operation example of the image reading unit illustrated in FIG. 2.

FIG. 10 is an explanatory diagram illustrating an operation example of the image reading unit illustrated in FIG. 2.

FIG. 11 is a flow diagram illustrating an operation example of an image reading unit according to a modified embodiment.

### DETAILED DESCRIPTION OF THE EMBODIMENTS

In the following, embodiments of the present invention are described with reference to the drawings.

### Configuration Example

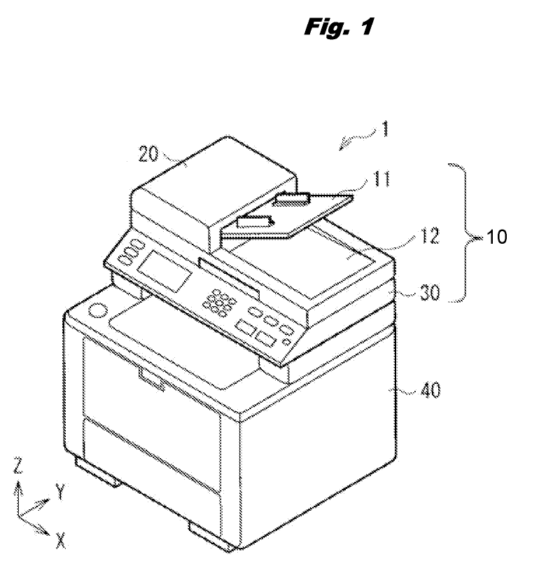

FIG. 1 illustrates a configuration example of a multifunction peripheral (MFP) that has an image reading device according to a first embodiment of the present invention. The multifunction peripheral 1 has functions of a copy machine, a facsimile, a scanner and the like. The multifunction peripheral 1 includes an image reading unit 10 and an image forming unit 40.

(Image Reading Unit 10)

The image reading unit 10 reads information printed on the manuscript medium 9. The image reading unit 10 is a so-called sheet feeding type. The image reading unit 10 has two operation modes M1, M2. The operation mode M1 is a mode in which information printed on the manuscript medium 9 is read by carrying the manuscript medium 9 using an auto document feeder (ADF) part 20 (to be described later). The operation mode M2 is a mode in which information printed on the manuscript medium 9 is read by directly setting the manuscript medium 9 by a user without using the ADF part 20.

The image reading unit 10 has the ADF part 20 and a scanner part 30. The ADF part 20 carries and guides one by one a plurality of manuscript media 9 to the scanner part 30 and ejects the manuscript medium 9, from which information has been read, to a stacker 12. The scanner part 30, in the operation mode M1, reads information printed on the manuscript medium 9 that is guided by the ADF part 20. Further, the scanner part 30, the operation mode M2, operates as a flat bed scanner. Specifically, in the operation mode M2, a user lifts the ADF part 20, and sets the manuscript medium 9 on an upper surface of the scanner part 30. The scanner part 30 reads information printed on the manuscript medium 9 that is directly set by the user in this way.

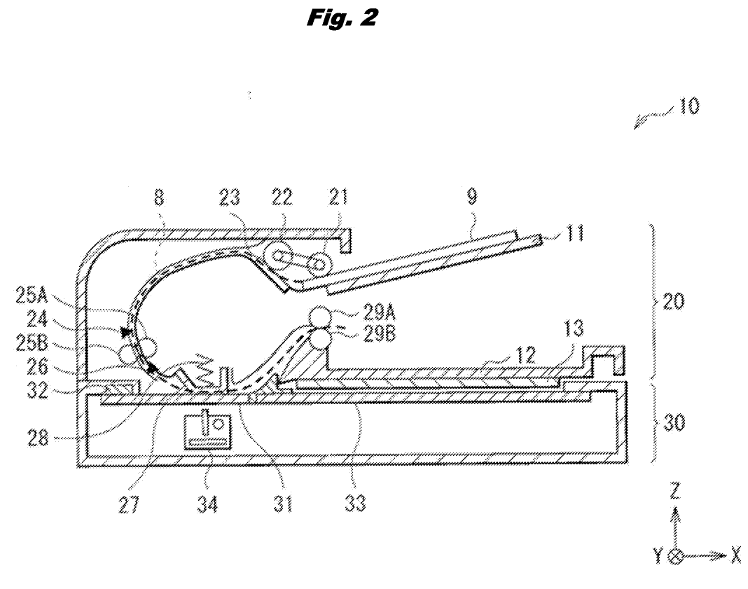

FIG. 2 illustrates a configuration example of the image reading unit 10. The ADF part 20 has a pickup roller 21, a separation roller 22, a separation pad 23, a registration sensor 24, a registration roller 25A, a pressure roller 25B, a scan sensor 26, a manuscript pressing member 27, a spring 28, an ejection roller 29A, a pressure roller 29B, and another manuscript pressing member 13.

The pickup roller 21 is a member that feeds the manuscript medium 9 that is set in the medium tray 11 to a carrying path 8. The pickup roller 21 is rotated by power transmitted from a motor 82 (to be described later).

The separation roller 22 and the separation pad 23 are members that separate manuscript media 9 fed by the pickup roller 21 one by one and feeds the manuscript media 9 to the carrying path 8. The separation roller 22 and the separation pad 23 are arranged opposing each other across the carrying path 8. The separation roller 22 is rotated by power transmitted from the motor 82 (to be described later). The separation pad 23 is configured such that friction occurs between the separation pad 23 and the manuscript medium 9.

The registration sensor 24 is a sensor that detects passage of the manuscript medium 9. The registration sensor 24 is provided on the carrying path 8 between the separation roller 22 and the registration roller 25A.

The registration roller 25A and the pressure roller 25B are members that correct a skew of the manuscript medium 9 passing through the carrying path 8. The registration roller 25A and the pressure roller 25B are arranged opposing each other across the carrying path 8. The pressure roller 25 is arranged so as to press against the registration roller 25A with a predetermined pressing amount. The registration roller 25A is rotated by power transmitted from the motor 82 (to be described later). Further, the pressure roller 25B is driven to rotate in response to the rotation of the registration roller 25A.

The scan sensor 26 is a sensor that detects passage of the manuscript medium 9. The scan sensor 26 is provided on a downstream side of the registration roller 25A in the carrying path 8.

The manuscript pressing member 27 is a member that guides the manuscript medium 9 to a surface of a reading glass 31 (to be described later) of the scanner part 30. A surface of the manuscript pressing member 27 on the reading glass 31 side is colored white. The spring 28 presses the manuscript pressing member 27 against the reading glass 31 (to be described later) of the scanner part 30.

The ejection roller 29A and the pressure roller 29B are members that guide the manuscript medium 9, from which information has been read, to the stacker 12. The ejection roller 29A and the pressure roller 29B are arranged opposing each other across the carrying path 8. The pressure roller 29B is arranged so as to press against the ejection roller 29A with a predetermined pressing amount. The ejection roller 29A is rotated by power transmitted from the motor 82 (to be described later). Further, the pressure roller 29B is driven to rotate in response to the rotation of the ejection roller 29A.

When the scanner part 30 operates as a flat bed scanner, the manuscript pressing member 13 is a member that presses the manuscript medium 9 that is set on the reading glass 33 (to be described later) of the scanner part 30 against the reading glass 33.

The scanner part 30 has the reading glass 31, a shading sheet 32, a reading glass 33, and a reading part 34.

The reading glass 31 is a member that is arranged at a position opposing the manuscript pressing member 27 of the ADF part 20. The reading part 34, in the operation mode M1, reads via the reading glass 31 information printed on the manuscript medium 9 that is guided by the ADF part 20.

The shading sheet 32 is a member for performing calibration of a result read by the reading part 34. Specifically, the shading sheet 32 is, for example, a white sheet, and the reading part 34 performs calibration of a read signal level by reading the shading sheet 32.

The reading glass 33 is a member that is arranged at a position opposing the manuscript pressing member 13 of the ADF part 20. The reading part 34, in the operation mode M2, reads via the reading glass 33 information printed on the manuscript medium 9 that is set by a user.

The reading part 34 generates read data RD by reading information printed on the manuscript medium 9. The reading part 34, for example, has a CIS (Contact Image Sensor) unit 34A.

FIG. 3 illustrates a configuration example of the CIS unit 34A. The CIS unit 34A has a plurality of lenses 36 and a plurality of chips 37 (seven chips 371-377 in this example).

The plurality of the lenses 36 are members that guide incident light to the seven chips 371-377. In this example, the plurality of the lenses 36 are arranged side by side in two rows in a Y direction. An arrangement pitch P of the lenses 36 in the Y direction can be set to, for example, about 0.3 mm. The two rows of the lenses are arranged such that positions of lenses are shifted by half the arrangement pitch P from each other between the two rows.

The seven chips 371-377 photoelectrically convert light guided by the plurality of the lenses 36 to electrical signals and perform predetermined processing. The seven chips 371-377 are arranged on a substrate 39 and are arranged side by side in the Y direction.

With this configuration, the reading part 34 generates the read data RD that includes red, green and blue detection signals.

Further, the reading part 34 is configured to be movable along an X direction by a sensor drive mechanism 83 (to be described later).

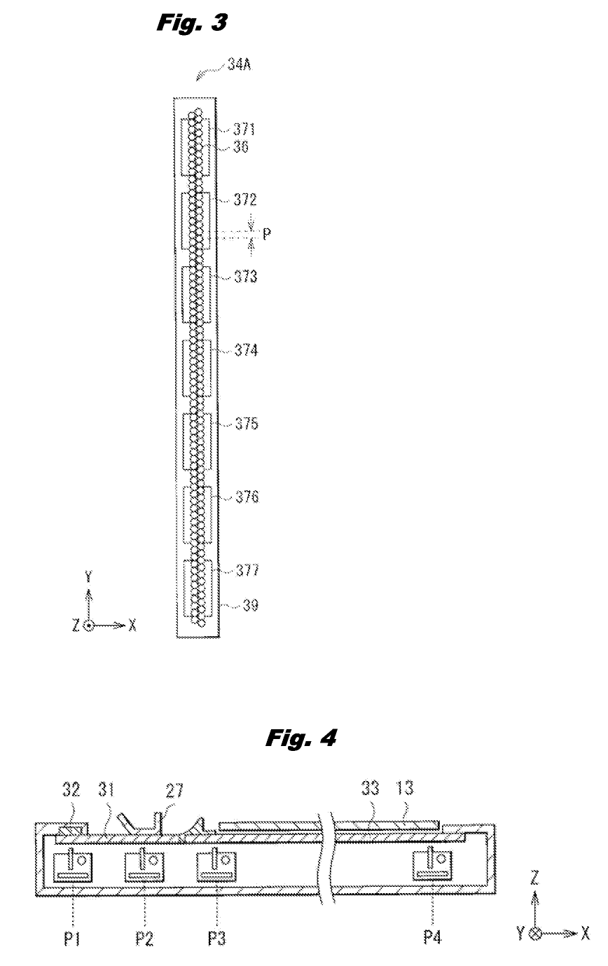

FIG. 4 illustrates an operation of the reading part 34. The reading part 34 in a standby state stops at a position P1, which corresponds to the shading sheet 32, in the X direction. In the operation mode M1, the reading part 34 moves from the position P1 to a position P2, which corresponds to the manuscript pressing member 27, in the X direction. This allows the reading part 34 to read via the reading glass 31 information printed on the manuscript medium 9 that is guided by the ADF part 20. Further, in the operation mode M2, the reading part 34 moves from the position P1 to a position P3, which corresponds to an edge of the manuscript pressing member 13, in the X direction. The reading part 34 reads via the reading glass 33 information printed on the manuscript medium 9 that is set by a user while gradually moving from the position P3 toward a position P4, which corresponds to an opposite side edge of the manuscript pressing member 13.

(Image Forming Unit 40)

The image forming unit 40 forms an image on a recording medium 7 using an electrophotographic method. Specifically, the image forming unit 40 in this example is a printer using an LED (Light Emitting Diode) tandem color method.

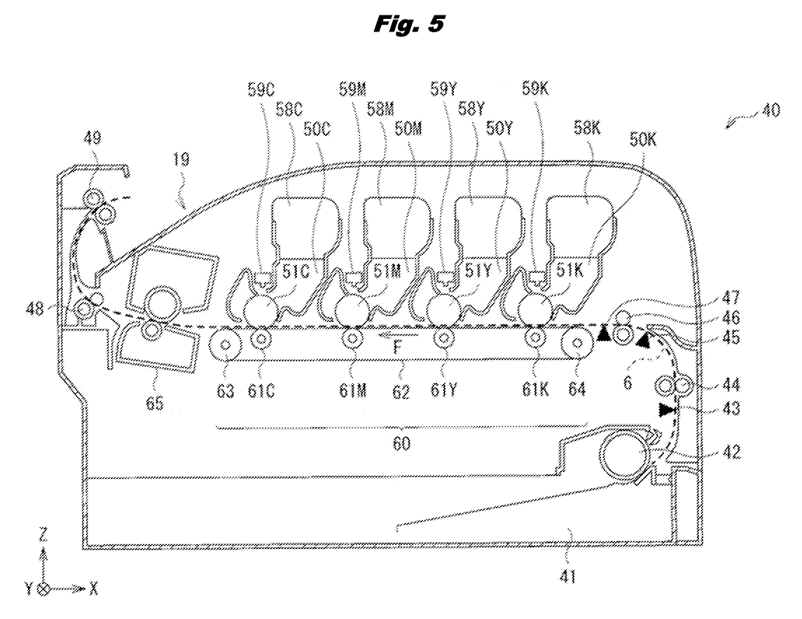

FIG. 5 illustrates a configuration example of the image forming unit 40. The image forming unit 40 includes a feed roller 42, a sensor 43, a registration roller 44, a sensor 45, a carrying roller 46, a sensor 47, four ID (Image Drum) units 50 (50K, 50Y, 50M, 50C), four toner containers 58 (58K, 58Y, 58M, 58C), four exposure heads 59 (59K, 59Y, 59M, 59C), a transfer part 60, a fuser 65, a carrying roller 48, and an ejection roller 49.

The feed roller 42 is a member that takes out recording media 7, which are set in a feed cassette, one by one from top of the stack and feeds each of the taken out recording media 7 to a carrying path 6. The sensor 43 is a sensor that detects passage of a recording medium 7. The registration roller 44 is a pair of rollers that are arranged opposing each other across the carrying path 6, and is a member that corrects a skew of a recording medium 7 that passes through the carrying path 6. The sensor 45 is a sensor that detects passage of a recording medium 7. The carrying roller 46 is a pair of rollers that are arranged opposing each other across the carrying path 6, and is a member that carries a recording medium 7 along the carrying path 6 and guides the recording medium 7 to the ID units 50. The sensor 47 is a sensor that detects timing for the ID units 50 and the exposure head 59 to start image formation.

The ID units 50 respectively form toner images. Specifically, the ID unit 50K forms a black toner image, the ID unit 50Y forms a yellow toner image, the ID unit 50M forms a magenta toner image, and the ID unit 50C forms a cyan toner image. In this example, the ID units 50 are arranged in the order of the ID units 50K, 50Y, 50M, 50C along a carrying direction F of the recording medium 7. The ID units 50, for example, are each configured to be detachable.

The ID units 50 respectively have photosensitive drums 51. The photosensitive drums 51 are members that each carry an electrostatic latent image on a surface (surface-layer portion). Specifically, in the photosensitive drum 51K of the ID unit 50K, by being exposed by the exposure head 59K, an electrostatic latent image is formed; in the photosensitive drum 51Y of the ID unit 50Y, by being exposed by the exposure head 59Y, an electrostatic latent image is formed; in the photosensitive drum 51M of the ID unit 50M, by being exposed by the exposure head 59M, an electrostatic latent image is formed; and in the photosensitive drum 51C of the ID unit 50C, by being exposed by the exposure head 59C, an electrostatic latent image is formed. Then, in the photosensitive drums 51, toner images are respectively formed based on the electrostatic latent images.

The toner containers 58 respectively contain toners. Specifically, the toner container 58K contains a black toner and is configured to be detachably attached to the ID unit 50K; the toner container 58Y contains a yellow toner and is configured to be detachably attached to the ID unit 50Y; the toner container 58M contains a magenta toner and is configured to be detachably attached to the ID unit 50M; and the toner container 58C contains a cyan toner and is configured to be detachably attached to the ID unit 50C.

The exposure heads 59 (FIG. 5) are members that respectively irradiate light to the photosensitive drums 51 and, for example, are each configured to include an LED. Specifically, the exposure head 59K irradiates light to the photosensitive drum 51K; the exposure head 59Y irradiates light to the photosensitive drum 51Y; the exposure head 59M irradiates light to the photosensitive drum 51M; and the exposure head 59C irradiates light to the photosensitive drum 51C. As a result, electrostatic latent images are respectively formed on the photosensitive drums 51.

The transfer part 60 is a member that transfers the toner images that are respectively formed by the four ID units 50 to a transferred surface of a recording medium 7. The transfer part 60 includes four transfer rollers 61 (61K, 61Y, 61M, 61C), a transfer belt 62, a drive roller 63, and a driven roller 64.

The transfer roller 61K is arranged opposing the photosensitive drum 51K across the carrying path 6; the transfer roller 61Y is arranged opposing the photosensitive drum 51Y across the carrying path 6; the transfer roller 61M is arranged opposing the photosensitive drum 51M across the carrying path 6; and the transfer roller 61C is arranged opposing the photosensitive drum 51C across the carrying path 6.

The transfer belt 62 carries a recording medium 7 along the carrying path 6. The transfer belt 62 is stretched by the drive roller 63 and the driven roller 64. The transfer belt 62 cyclically rotates in the carrying direction F in response to the rotation of the drive roller 63.

The drive roller 63 causes the transfer belt 62 to cyclically rotate. In this example, the drive roller 63 is arranged on a downstream side of the four ID units 50 in the carrying direction F. The driven roller 64 is driven to rotate in response to the cyclic rotation of the transfer belt 62. In this example, the driven roller 64 is arranged on an upstream side of the four ID units 50 in the carrying direction F.

The fuser 65 is a member that fuses a toner image on a recording medium 7 by applying heat and pressure to the recording medium 7, the toner image having been transferred onto the recording medium 7.

The carrying roller 48 is a pair of rollers that are arranged opposing each other across the carrying path 6, and is a member that carries a recording medium 7, on which a toner image has been fused, along the carrying path 6. The ejection roller 49 is a pair of rollers that are arranged opposing each other across the carrying path 6, and is a member that ejects the recording medium 7 carried by the carrying roller 48 to the stacker 19.

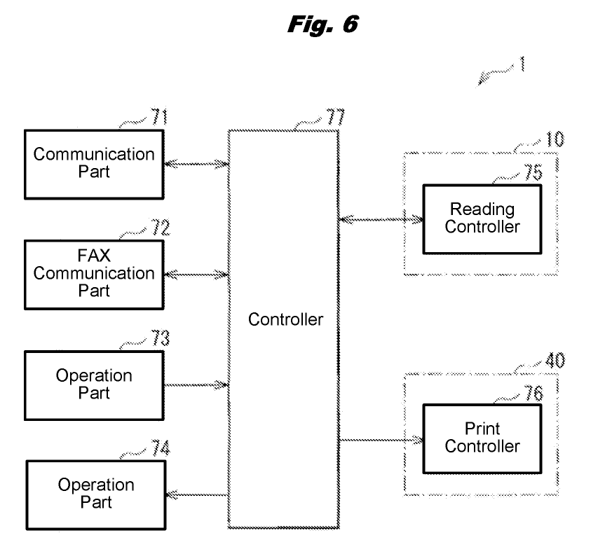

(Control Mechanism of Multifunction Peripheral 1) FIG. 6 illustrates an example of a control mechanism of the multifunction peripheral 1. The multifunction peripheral 1 includes a communication part 71, a FAX communication part 72, an operation part 73, a display part 74, a reading controller 75, a print controller 76, and a controller 77.

The communication part 71 in this example receives print data from a host computer by communicating with the host computer. The communication part 71, for example, may be connected to a host computer by a USB (Universal Serial Bus) or may be connected to a host computer via a LAN (Local Area Network). The FAX communication part 72 transmits data to and receives data from a communication partner via a telephone line. The operation part 73 receives an operation of a user and is configured, for example, using a touch panel, various buttons and the like. The display part 74 displays a state of the multifunction peripheral 1 or the like and is configured, for example, using a liquid crystal display or the like. The reading controller 75 controls operations of the members of the image reading unit 10. The print controller 76 controls operations of the members of the image forming unit 40.

The controller 77 controls operations of these blocks. As a result, for example, when a user uses the operation part 73 to instruct the multifunction peripheral 1 to perform a copy operation, the controller 77 instructs the reading controller 75 to read information printed on the manuscript medium 9 and instructs the print controller 76 to print a read image. Further, for example, when a user instructs from a host computer the multifunction peripheral 1 to perform printing based on print data, the controller 77 instructs the print controller 76 to perform printing based on the print data. Further, for example, when a user uses the operation part 73 to instruct the multifunction peripheral 1 to perform a FAX transmission operation, the controller 77 instructs the reading controller 75 to read information printed on the manuscript medium 9 and instructs the FAX communication part 72 to transmit a read image to a communication partner. Further, for example, when a user uses the operation part 73 to instruct the multifunction peripheral 1 to perform a read operation, the controller 77 instructs the reading controller 75 to read information printed on the manuscript medium 9 and instructs the communication part 71 to transmit a read image to, for example, a host computer.

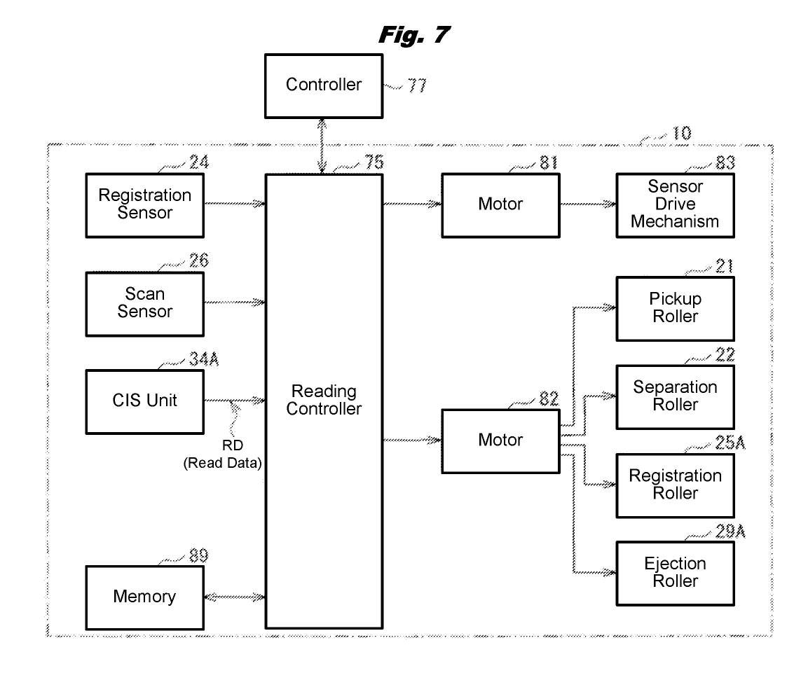

FIG. 7 illustrates an example of a control mechanism of the image reading unit 10. The image reading unit 10 has motors 81, 82, a sensor drive mechanism 83, and a memory 89.

The motor 81 supplies power to the sensor drive mechanism 83. Based on the power supplied from the motor 81, the sensor drive mechanism 83 moves the reading part 34 along the X direction. The motor 82 supplies power to the pickup roller 21, the separation roller 22, the registration roller 25A and the ejection roller 29A. The memory 89 stores the read data RD generated by the image reading unit 10.

When instructed by the controller 77 to read information printed on the manuscript medium 9 by operating in the operation mode M1, the reading controller 75 first causes the motor 81 to operate to move the reading part 34 from the position P1 to the position P2 (FIG. 4), and causes the motor 82 to operate to rotate the rollers. As a result, the manuscript medium 9 is carried along the carrying path 8. Thereafter, the reading controller 75 receives from the registration sensor 24 and the scan sensor 26 a signal indicating passage of the manuscript medium 9. Then, the reading controller 75 receives read data RD from the CIS unit 34A, and temporarily stores the read data RD in the memory 89. Then, the reading controller 75 supplies the read data RD stored in the memory 89 to the controller 77.

In doing so, as will be described later, based on the read data RD supplied from the CIS unit 34A, the reading controller 75 detects arrival of a leading edge of the manuscript medium 9 at the reading part 34. Then, based on a result of the detection, the reading controller 75 starts the writing of the read data RD to the memory 89.

Further, when instructed by the controller 77 to read information printed on the manuscript medium 9 by operating in the operation mode M2, the reading controller 75 first causes the motor 81 to operate to move the reading part 34 from the position P1 to the position P3 (FIG. 4). Then, the reading controller 75 receives read data RD from the CIS unit 34A while gradually moving the reading part 34 from the position P3 toward the position P4, and temporarily stores the read data RD in the memory 89. Then, the reading controller 75 supplies the read data RD stored in the memory 89 to the controller 77.

The reading controller 75, for example, may be configured using hardware, or may be configured using software such as firmware.

Here, the reading controller 75 corresponds to a specific example of a “controller” of the present invention. The plurality of the chips 37 correspond to a specific example of “a plurality of reading sensors” of the present invention. The pickup roller 21, the separation roller 22, the registration roller 25A, and the pressure roller 25B correspond to a specific example of “a plurality of carrying rollers” of the present invention. The registration sensor 24 and the scan sensor 26 correspond to a specific example of a “second sensor” of the present invention.

[Operation and Effect]

Next, operation and effect of the multifunction peripheral 1 of the present embodiment is described.

(Overall Operation Overview)

First, with reference to FIGS. 1-7, an overall operation overview of the multifunction peripheral 1 is described. Here, a case is described as an example in which a user uses the operation part 73 (FIG. 6) to instruct the multifunction peripheral 1 to perform a copy operation. The controller 77 first instructs the reading controller 75 of the image reading unit 10 to read information printed on the manuscript medium 9.

When the image reading unit 10 operates in the operation mode M1, in the image reading unit 10, the reading controller 75 (FIG. 7) first causes the motor 81 to operate to move the reading part 34 from the position P1 to the position P2 (FIG. 4), and causes the motor 82 to operate to rotate the rollers. The pickup roller 21 feeds the manuscript medium 9 that is set in the medium tray 11 to the carrying path 8. The separation roller 22 and the separation pad 23 separate manuscript media 9 fed by the pickup roller 21 one by one and feed the manuscript media 9 to the carrying path 8. The registration sensor 24 detects passage of the manuscript medium 9, and supplies a signal indicating the passage of the manuscript medium 9 to the reading controller 75. The registration roller 25A and the pressure roller 25B correct a skew of the manuscript medium 9 passing through the carrying path 8. The scan sensor 26 detects passage of the manuscript medium 9, and supplies a signal indicating the passage of the manuscript medium 9 to the reading controller 75. Then, the manuscript medium 9 passes through between the reading glass 31 and the manuscript pressing member 27. The CIS unit 34A of the reading part 34 reads information printed on the manuscript medium 9 and generates read data RD. The reading controller 75 temporarily stores the read data RD in the memory 89. Then, the reading controller 75 supplies the read data RD stored in the memory 89 to the controller 77. The ejection roller 29A and the pressure roller 29B guide the manuscript medium 9, from which the information has been read, to the stacker 12.

When the image reading unit 10 operates in the operation mode M2, the reading controller 75 (FIG. 7) first causes the motor 81 to operate to move the reading part 34 from the position P1 to the position P3 (FIG. 4). The manuscript medium 9 is sent to below the manuscript pressing member 13. When reaching the downstream edge of the member 13, the manuscript medium 9 stays at the position. Then, the reading controller 75 causes the reading part 34 to gradually move from the position P3 toward the position P4, completing to read an entire of the manuscript medium 9. The CIS unit 34A of the reading part 34 reads information printed on the manuscript medium 9 and generates read data RD. The reading controller 75 temporarily stores the read data RD in the memory 89. Then, the reading controller 75 supplies the read data RD stored in the memory 89 to the controller 77.

Next, based on the read data RD, the controller 77 (FIG. 6) instructs the print controller 76 of the image forming unit 40 to perform a print operation.

In the image forming unit 40, based on the read data RD, the print controller 76 controls operations of the members of the image forming unit 40 (FIG. 5), including the four exposure heads 59, the four ID units 50, the four transfer rollers 61, the fuser 65, the various rollers, and the like. Specifically, the exposure head 59K and the ID unit 50K form a toner image of a black toner; the exposure head 59Y and the ID unit 50Y form a toner image of a yellow toner; the exposure head 59M and the ID unit 50M form a toner image of a magenta toner; and the exposure head 59C and the ID unit 50C form a toner image of a cyan toner. The four transfer rollers 61 transfer the four toner images that are generated on the four photosensitive drums 51 onto a recording medium 7. The fuser 65 fuses the toner image on the recording medium 7. In this way, the printed recording medium 7 is ejected from the image forming unit 40.

(Detailed Operation of Image Reading Unit 10 in Operation Mode M1)

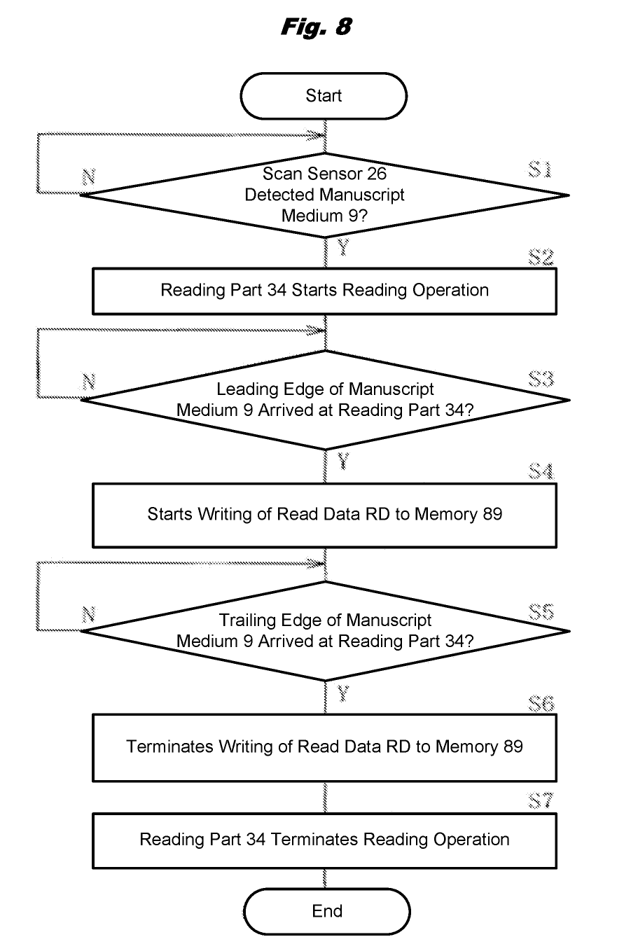

FIG. 8 illustrates an operation example of the image reading unit 10. The ADF part 20 carries and guides one by one a plurality of manuscript media 9 that are set in the medium tray 11 to the scanner part 30. The scanner part 30 reads information printed on the manuscript medium 9 that is guided by the ADF part 20. In doing so, the reading controller 75 detects arrival of a leading edge of the manuscript medium 9 at the reading part 34 based on the read data RD supplied from the CIS unit 34A, and starts the writing of the read data RD to the memory 89 based on a result of the detection. In the following, this operation is described in detail.

First, when carrying of the manuscript medium 9 is started, the reading controller 75 confirms whether or not the scan sensor 26 has detected the manuscript medium 9 (S1). When the scan sensor 26 has not yet detected the manuscript medium 9 (“N” at S1), the processing returns to S1. The reading controller 75 repeats S1 until the scan sensor 26 detects the manuscript medium 9.

When, at S1, the scan sensor 26 has detected the manuscript medium 9 (“Y” at S1), the reading controller 75 controls the reading part 34 to start a reading operation (S2). Specifically, the reading controller 75 controls the chips 37 included in the CIS unit 34A of the reading part 34 to start photoelectric conversion. As a result, the CIS unit 34A generates the read data RD and sequentially supplies the read data RD to the reading controller 75. Scan sensor 26 serves as a medium detection sensor that initiates the reading operation. Registration sensor 24 as well may serve as the medium detection sensor.

Next, based on the read data RD, the reading controller 75 confirms whether or not a leading edge of the manuscript medium 9 has arrived at the reading part 34 (S3).

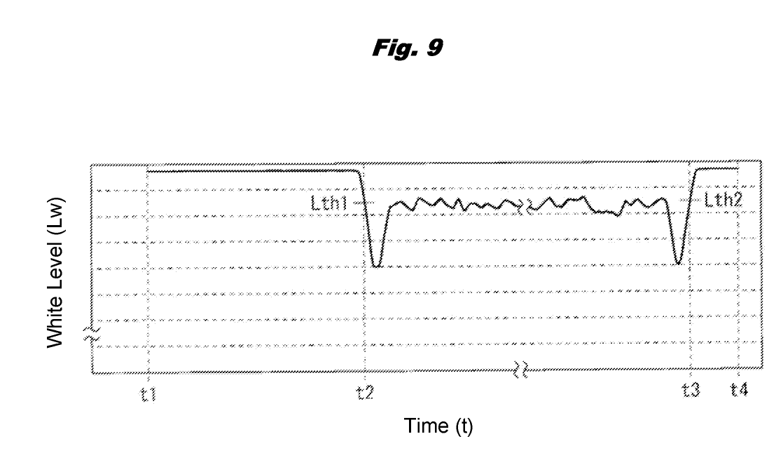

FIG. 9 illustrates a detection operation of the leading edge of the manuscript medium 9. The reading controller 75 obtains a white level Lw based on red, green and blue detection signals included in the read data RD. When the white level Lw is below a predetermined threshold level Lth1, the reading controller 75 judges that the leading edge of the manuscript medium 9 has arrived at the reading part 34.

In this example, at a timing t1, the reading part 34 starts a reading operation and starts generating read data RD, and the reading controller 75 obtains a white level Lw based on the read data RD. During a time period between timings t1-t2, the white level Lw maintains a high level corresponding to a color of the manuscript pressing member 27. Thereafter, the white level Lw decreases. That is, the leading edge of the manuscript medium 9 arrives at the reading part 34, and the reading part 34 reads a shadow of a vicinity of the leading edge of the manuscript medium 9. Therefore, the white level Lw decreases. In this case, at the timing t2, the white level Lw is below the threshold level Lth1. At the timing t2, the reading controller 75 judges that the leading edge of the manuscript medium 9 has arrived at the reading part 34.

At S3, when the leading edge of the manuscript medium 9 has not yet arrived at the reading part 34 (“N” at S3), the processing returns to S3. The reading controller 75 repeats S3 until the leading edge of the manuscript medium 9 arrives at the reading part 34.

At S3, when the leading edge of the manuscript medium 9 has arrived at the reading part 34 (“Y” at S3), the reading controller 75 starts the writing of the read data RD to the memory 89 (S4). That is, the reading controller 75 discards the read data RD obtained until the timing t2 in FIG. 9, and stores the read data RD obtained after the timing t2 in the memory 89. As a result, the information printed on the manuscript medium 9 is stored as the read data RD in the memory 89.

Next, based on the read data RD, the reading controller 75 confirms whether or not a trailing edge of the manuscript medium 9 has arrived at the reading part 34 (S5).

As illustrated in FIG. 9, the white level Lw temporarily decreases immediately before a timing t3. That is, in this case, the trailing edge of the manuscript medium 9 approaches the reading part 34, and the reading part 34 reads a shadow of a vicinity of the trailing edge of the manuscript medium 9. Therefore, the white level Lw decreases. Thereafter, the white level Lw rises to the high level corresponding to the color of the manuscript pressing member 27. In this case, at the timing t3, the white level Lw is above a threshold level Lth2. When the white level Lw is above the predetermined threshold level Lth2, the reading controller 75 judges that the trailing edge of the manuscript medium 9 has arrived at the reading part 34.

At S5, when the trailing edge of the manuscript medium 9 has not yet arrived at the reading part 34 (“N” at S5), the processing returns to S5. The reading controller 75 repeats S5 until the trailing edge of the manuscript medium 9 arrives at the reading part 34.

At S5, when the trailing edge of the manuscript medium 9 has arrived at the reading part 34 (“Y” at S5), the reading controller 75 terminates the writing of the read data RD to the memory 89 (S6). That is, the reading controller 75 stores the read data RD obtained until the timing t3 in the memory 89 and discards the read data RD obtained after the timing t3 in FIG. 9.

Next, the reading controller 75 controls the reading part 34 to terminate the reading operation (S7). Specifically, the reading controller 75 controls the chips 37 included in the CIS unit 34A of the reading part 34 to terminate the photoelectric conversion. As a result, the CIS unit 34A terminates generation of the read data RD.

The flow of the processing as described above is terminated.

In this way, in the multifunction peripheral 1, based on the generated read data RD, the reading part 34 starts the writing of the read data RD to the memory 89. Therefore, the information printed on the manuscript medium 9 can be properly read. That is, for example, in a case where, based on a result of detection by the scan sensor 26, a timing of arrival of the manuscript medium 9 at the reading part 34 is predicted and the writing of the read data RD to the memory 89 starts at the predicted arrival timing, there is a risk that the predicted arrival timing does not match an actual timing of arrival of the leading edge of the manuscript medium 9 at the reading part 34. Specifically, for example, it is possible that there is a physical error in an attachment position of the scan sensor 26 on the carrying path 8. Therefore, there is a risk that the predicted arrival timing may deviate from the actual arrival timing. Further, depending on rigidity of the manuscript medium 9, a difference in carrying route can occur in the carrying path 8. Therefore, there is a risk that the predicted arrival timing may deviate from the actual arrival timing. Further, depending on an acceleration state in a carrying operation, there is a risk that the predicted arrival timing may deviate from the actual arrival timing. As a result, there is a risk that the actual timing of arrival of the leading edge of the manuscript medium 9 at the reading part 34 deviates from the timing of starting the writing of the read data RD to the memory 89, and, for example, information printed near the leading edge of the manuscript medium 9 is not read.

On the other hand, in the multifunction peripheral 1, the arrival of the leading edge of the manuscript medium 9 at the reading part 34 is detected based on the read data RD generated by the reading part 34, and wiring the read data RD to the memory 89 starts based on a result of the detection. As a result, in the multifunction peripheral 1, the actual timing of the arrival of the manuscript medium 9 at the reading part 34 and the timing to start the writing of the read data RD to the memory 89 can be synchronized. As a result, in the multifunction peripheral 1, for example, information printed near the leading edge of the manuscript medium 9 can be properly read.

Further, in the multifunction peripheral 1, the wiring of the read data RD to the memory 89 is terminated based on the read data RD generated by the reading part 34. Therefore, similarly, information printed near the trailing edge of the manuscript medium 9 can be properly read.

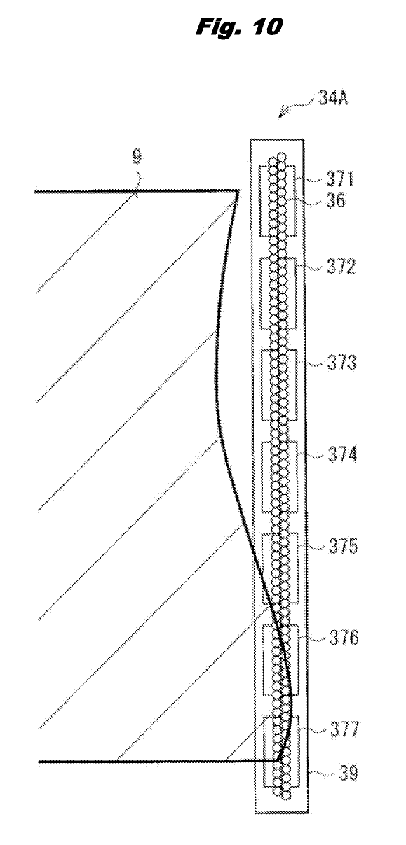

Further, in the multifunction peripheral 1, arrivals of the leading edge and the trailing edge of the manuscript medium 9 at the reading part 34 are detected based on the read data RD generated by the chips 37 of the reading part 34. Therefore, even when the leading edge of the manuscript medium 9 is not flat or the trailing edge of the manuscript medium 9 is not flat, the information printed on the manuscript medium 9 can be properly read. That is, for example, in the case illustrated in FIG. 10, a portion of the leading edge of the manuscript medium 9 (lower side in FIG. 10) arrives at the reading part 34 (CIS unit 34A). In this case, suppose that the reading part 34 is configured such that only the chip 374 positioned at a center of the reading part 34 performs a reading operation and the arrival of the leading edge of the manuscript medium 9 at the reading part 34 is detected based on the read data RD generated by the chip 374, there is a risk that the timing to start the writing of the read data RD to the memory 89 is delayed and the information printed near the leading edge of the manuscript medium 9 is not read. On the other hand, in the multifunction peripheral 1, the chips 37 of the reading part 34 are caused to operate. Therefore, in this example, based on read data RD generated by the chip 376 among the seven chips 37, the arrival of the leading edge of the manuscript medium 9 at the reading part 34 can be detected. As a result, in the multifunction peripheral 1, the information printed on the manuscript medium 9 can be properly read.

Further, in the multifunction peripheral 1, the reading part 34 starts the reading operation when the scan sensor 26 detects the manuscript medium 9. Therefore, power consumption can be reduced. That is, for example, in a case where the reading part 34 starts a reading operation when the manuscript medium 9 is set in the medium tray 11 or when the registration sensor 24 detects the manuscript medium 9, the reading part 34 performs processing such as photoelectric conversion over a longer period of time and thus there is a risk that power consumption may increase. On the other hand, in the multifunction peripheral 1, the reading part 34 starts a reading operation when the scan sensor 26, which is close to the reading part 34, detects the manuscript medium 9. Therefore, a time period in which the reading part 34 performs the reading operation can be shortened and thus power consumption can be reduced.

[Effects]

As described above, in the present embodiment, the writing of the read data to the memory starts based on the read data generated by the reading part. Therefore, the information printed near the leading edge of the manuscript medium can be properly read. Further, similarly, the writing of the read data to the memory is terminated based on the read data generated by the reading part. Therefore, the information printed near the trailing edge of the manuscript medium can be properly read.

In the present embodiment, arrivals of the leading edge and the trailing edge of the manuscript medium 9 at the reading part 34 are detected based on the read data generated by the chips of the reading part. Therefore, even when the leading edge of the manuscript medium is not flat or the trailing edge of the manuscript medium is not flat, the information printed on the manuscript medium can be properly read.

In the present embodiment, the reading part starts the reading operation when the scan sensor detects the manuscript medium. Therefore, power consumption can be reduced.

### First Modification Embodiment

In the above embodiment, the writing of the read data RD to the memory 89 is terminated based on the read data RD generated by the reading part 34. However, the present invention is not limited to this. Instead of this, for example, it is also possible that the writing of the read data RD to the memory 89 is terminated based on a result of detection by the registration sensor 24 or the scan sensor 26. The registration sensor 24 and the scan sensor 26 correspond to a specific example of a “first sensor” of the present invention. In the following, an example in which the writing to the memory 89 is terminated based on a result of detection by the registration sensor 24 is described in detail.

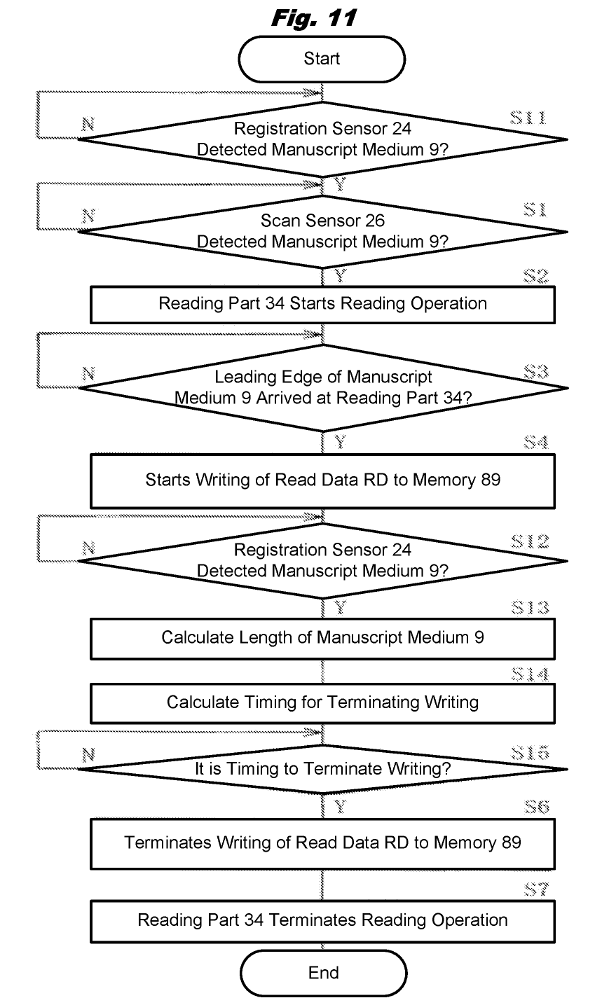

FIG. 11 illustrates an operation example of an image reading unit 10A according to the present modified embodiment.

First, when carrying of the manuscript medium 9 is started, a reading controller 75A of the image reading unit 10A confirms whether or not the registration sensor 24 has detected the manuscript medium 9 (S11). When the registration sensor 24 has not yet detected the manuscript medium 9 (“N” at S11), the processing returns to S11. The reading controller 75A repeats S11 until the registration sensor 24 detects the manuscript medium 9.

When, at S11, the registration sensor 24 has detected the manuscript medium 9 (“Y” at S11), the reading controller 75A confirms whether or not the scan sensor 26 has detected the manuscript medium 9 (S1). Next, when the scan sensor 26 has detected the manuscript medium 9 (“Y” at S1), the reading controller 75A controls the reading part 34 to start a reading operation (S2). Next, based on the read data RD, the reading controller 75A confirms whether or not the leading edge of the manuscript medium 9 has arrived at the reading part 34 (S3). When the leading edge of the manuscript medium 9 has arrived at the reading part 34 (“Y” at S3), the reading controller 75A starts the writing of the read data RD to the memory 89 (S4). The operations of S1-S4 are the same as in the case of the above embodiment.

Next, the reading controller 75A confirms whether or not the registration sensor 24 has detected the manuscript medium 9 (S12). When registration sensor 24 continues to detect the manuscript medium 9 (“Y” at S12), the processing returns to S12. Next, the reading controller 75A repeats S12 until the registration sensor 24 no longer detects the manuscript medium 9.

When, at S12, the registration sensor 24 no longer detects the manuscript medium 9 (“Y” at S12), based on the timing when the registration sensor 24 starts to detect the manuscript medium 9 at S11 and the timing when the registration sensor 24 finishes detecting the manuscript medium 9 at S12, the reading controller 75A calculates a length of the manuscript medium 9 (S13). In the embodiment, registration sensor 24 serves as a medium detection sensor.

Next, the reading controller 75A calculates timing for terminating the writing to the memory 89 (S14). Specifically, based on the timing when the writing of the read data RD to the memory 89 is started at S4 and the length of the manuscript medium 9 calculated at S13, the reading controller 75A calculates the timing of the arrival of the trailing edge of the manuscript medium 9 at the reading part 34 and, based on this timing, calculates the timing to terminate the writing to the memory 89.

Next, the reading controller 75A confirms whether or not it is the timing to terminate the writing (S15). When it is not the timing to terminate the writing (“N” at S15), the processing returns to S15. The reading controller 75A repeats S15 until it is the timing to terminate the writing.

At S15, when it is the timing to terminate the writing (“Y” at S15), the reading controller 75A terminates the writing of the read data RD to the memory 89 (S6). Next, the reading controller 75A controls the reading part 34 to terminate the reading operation (S7).

### Second Modification Embodiment

In the above embodiment, based on the read data RD generated by the chips 37 of the reading part 34, the arrival of the leading edge of the manuscript medium 9 at the reading part 34 is detected. However, the present invention is not limited to this. Instead of this, for example, it is also possible that only some of the plurality of the chips 37 perform a reading operation and the arrival of the leading edge of the manuscript medium 9 at the reading part 34 is detected based on read data RD generated by the some of the chips 37. In this case, based on a result of the detection, the reading controller 75 causes the other chips 37 to start a reading operation and starts writing of read data RD generated by the chips 37 to the memory 89. As a result, power consumption can be reduced.

### Third Modification Embodiment

In the above embodiment, the reading part 34 starts the reading operation when the scan sensor 26 detects the manuscript medium 9. However, the present invention is not limited to this. Instead of this, for example, it is also possible that the reading part 34 starts the reading operation when the manuscript medium 9 is set in the medium tray 11 or when the registration sensor 24 detects the manuscript medium 9.

Further, the invention may be performed without sensors 24, 26 (or medium detection sensor). For example, while supply roller 42 rotates, the reading part can continue to read data. Those data read by the reading part while the supply roller rotates are to be discarded until the leading edge of the manuscript medium is detected by the controller. In addition, various types of actions may be applied to initiate the reading operation. As discussed above, setting the manuscript medium in the tray and detecting the medium by registration sensor 24 are practically available to perform the invention. Those variations reduce the number of components, manufacturing process and labor fee as well.

In the above, the present invention is described by illustrating a few embodiments and modified embodiments. However, the present invention is not limited to these embodiments and the like, and various modifications are possible.

For example, in the above-described embodiments, the present invention is applied to the multifunction peripheral 1. However, the present invention is not limited to this. Instead of this, for example, the present invention can also be applied to a copying machine or a facsimile. Further, for example, the present invention may also be applied to a scanner that does not have a print function.

Further, for example, in the above-described embodiments, the reading part 34 is configured to use a CIS to read an image. However, the present invention is not limited to this. Instead of this, for example, it is also possible to use a CCD (Charge-Coupled Device) image sensor to read an image.

Further, for example, in the above-described embodiments, the image forming unit 40 is a printer using an LED tandem method. However, the present invention is not limited to this. Instead of this, for example, it is also possible that the image forming unit 40 is a printer using a laser method. Further, the image forming unit 40 is a printer using an electrophotographic method. However, the present invention is not limited to this. Instead of this, for example, it is also possible that the image forming unit 40 is a printer using an inkjet method or a printer using a dot matrix impact method.

Further, for example, in the above-described embodiments, the image forming unit 40 is configured to be capable of forming a color image. However, the present invention is not limited to this. Instead of this, for example, it is also possible that the image forming unit 40 is configured to be capable of forming a black and white image.

The above embodiments disclose to use a white level in order to recognize a leading edge of a medium that is carried along a medium carrying path. The invention, however, is not necessarily limited to those embodiments. The leading edge may be recognized by detecting a shadow of the leading edge that is created from light emitted from a light source.

What is claimed is:

1. An image reading device, comprising:
a carrying part that carries a manuscript medium along a carrying path along which the manuscript medium is carried;
a reading part that is arranged on the carrying path and sequentially generates read data by performing a reading operation;
a memory that stores the read data by performing a writing operation; and
a controller that detects a leading edge of the manuscript medium based on the read data and starts the writing operation of the read data to the memory based on a result of the detection.

2. The image reading device according to claim 1, wherein
the controller further detects a trailing edge of the manuscript medium based on the read data and terminates the writing operation of the read data based on a result of the detection.

3. The image reading device according to claim 1, further comprising:
a first sensor that detects the manuscript medium, wherein
the reading part and the first sensor are arranged along the carrying path,
the first sensor is arranged at a second position that is on an upstream side of a first position where the reading part is arranged, and
the controller further obtains a timing for terminating the writing operation of the read data based on a result of the detection by the first sensor.

4. The image reading device according to claim 1, wherein
the reading part is composed with a plurality of reading sensors that are arranged substantially perpendicular to a carrying direction of the manuscript medium on the carrying path,
the controller causes only a predetermined number of reading sensors among the entire reading sensors to perform the reading operation, the predetermined number being less than all of the reading sensors, and detects the leading edge of the manuscript medium based on read data generated by the predetermined number of reading sensors, and
after the reading part detects the leading edge of the manuscript medium, the controller activates all of the reading sensors for the reading operation.

5. The image reading device according to claim 4, wherein
the predetermined number of reading sensors are arranged near a center of the reading sensors.

6. The image reading device according to claim 1 wherein
the reading part is composed with a plurality of reading sensors that are arranged substantially perpendicular to a carrying direction of the manuscript medium on the carrying path,
the controller causes all of the reading sensors to perform the reading operation and detects the leading edge of the manuscript medium based on read data generated by the reading sensors, and
the reading part performs the reading operation using all of the reading sensors.

7. The image reading device according to claim 3, further comprising:
a second sensor that detects the manuscript medium, wherein
the reading part and the second sensor are arranged along the carrying path,
the second sensor is arranged at a third position that is on the upstream side of the first position where the reading part is arranged, and
the controller starts the writing operation of the read data based on a result of the detection by the second sensor.

8. The image reading device according to claim 7, wherein
the carrying part has a plurality of carrying rollers that are arranged on the carrying path, and
the second sensor is arranged between one of the carrying rollers, which is the closest to the reading part among the carrying rollers on the carrying path, and the reading part.

9. The image reading device according to claim 1, wherein
the controller obtains a white level based on the read data and detects the leading edge of the manuscript medium based on a change of the white level, the white level being a numeral value indicating a whiteness of an image produced from the read data.

10. The image reading device according to claim 1, further comprising:
a medium detection sensor that detects a presence of the manuscript medium on the carrying path, wherein
the medium detection sensor
is arranged at an upstream from the reading part in the carrying path, and
causes the reading part to initiate the reading operation when detecting the presence of the manuscript medium, and
the reading part continues to discard the read data until the leading edge of the manuscript medium is detected by the controller.

11. The image reading device according to claim 1, further comprising:
a medium detection sensor that detects a presence of the manuscript medium on the carrying path, wherein
the controller determines a length of the manuscript medium using the medium detection sensor,
the controller stops the writing operation of the read data to the memory in correspondence with a timing determined by the length of the manuscript medium.

12. The image reading device according to claim 4, wherein
after the predetermined number of reading sensors detects the leading edge of the manuscript medium, the controller performs the reading operation using all of the reading sensors.
